(19) United States
(12) Patent Application Publication
(10) Pub. No.: US 2024/0421394 A1
(43) Pub. Date: Dec. 19, 2024

(54) THERMOFORMED TOP COVER FOR BATTERY COMPONENTS

(71) Applicant: SABIC GLOBAL TECHNOLOGIES B.V., BERGEN OP ZOOM (NL)

(72) Inventors: Amol Prabhakar Avhad, Bengaluru (IN); Carlos Pereira Cadena, Putnam Valley, NY (US); Petya Dochkova Yaneva, Maastricht (NL)

(21) Appl. No.: 18/701,717

(22) PCT Filed: Oct. 20, 2022
(86) PCT No.: PCT/EP2022/079225

§ 371 Date: Apr. 16, 2024

Related U.S. Application Data
(60) Provisional application No. 63/270,800, filed on Oct. 22, 2021.

(30) Foreign Application Priority Data
Oct. 22, 2021 (EP) 21204333.5

(51) Int. Cl. H01M 50/162; B60K 1/04; H01M 50/133; H01M 50/143; H01M 50/148; H01M 50/249

(52) U.S. Cl. CPC H01M 50/162; B60K 1/04; H01M 50/133; H01M 50/143; H01M 50/148; H01M 50/249; B60K 2001/0438

(57) ABSTRACT

Disclosed is an article for covering battery components in an automotive prime-mover battery pack, the article comprising a top cover having an outer major surface and an inner major surface that is shaped to conform to the battery components, wherein the top cover is prepared by extrusion of a composition comprising a polyolefin and glass fibers to obtain a sheet and subsequent thermoforming of the sheet and wherein the article is configured to form an outer char coating when exposed to flame.

### TECHNICAL FIELD

The present subject matter relates to an article for covering battery components in an automotive prime-mover battery pack.

### BACKGROUND

Due to stringent worldwide carbon dioxide emission regulations, there is a greater focus on developing and using electric vehicles. Weight reduction is key to the viability of electric vehicles, because reducing the weight of the electric vehicles can extend their range.

One area of focus for weight reduction is the automotive prime-mover battery pack. An example of the automotive prime-mover battery pack is shown in FIG. 1 of US2012/0160088, which shows a perspective view of a portion of a vehicle body 100 and frame with the battery pack 101 separated from the structure. Compared to starting, lighting and ignition (SLI) batteries, automotive prime-mover battery packs are large. In this example of US2012/0160088, the battery pack 101 is approximately 2.7 meters long and 1.5 meters wide and has a thickness that varies between approximately 0.1 meters to 0.18 meters.

Due to its size, the weight reduction in the automotive prime-mover battery pack gives a substantial overall weight reduction. Currently most automotive prime-mover packs use aluminum or high strength steel designs. These designs provide structural integrity and mechanical protection during an impact as well as fire protection properties. However, they are heavy. They further require complex extrusion process, welding process and machining process and require many bolts.

Polymeric covers present integration challenges and to date are not commonly used. It has been considered more difficult for polymeric covers to show satisfactory fire protection properties than metal covers. Metal-plastic hybrid solutions can give unfavorable increase in design complexity.

Improved materials, and applications of materials, for EV battery pack covers are therefore desired.

### BRIEF SUMMARY

Disclosed is an article for covering battery components in an automotive prime-mover battery pack, the article comprising a top cover having an outer major surface and an inner major surface that is shaped to conform to the battery components, wherein the top cover is prepared by extrusion and subsequent thermoforming of a composition comprising a polyolefin and glass fibers and wherein the article is configured to form an outer char coating when exposed to flame.

Disclosed herein is an article for covering battery components in an automotive prime-mover battery pack. The article comprises a top cover having an outer major surface and an inner major surface that is shaped to conform to the battery components. The top cover is prepared by extrusion of a thermoplastic polymer composition comprising a polyolefin and glass fibers into a sheet and subsequent thermoforming. The article is configured to form an outer char coating when exposed to flame.

In the present disclosure, the terms “composition comprising a polyolefin and glass fibers” and “thermoplastic polymer composition comprising a polyolefin and glass fibers” are used interchangeably.

The article according to various examples comprises glass fibers which provide improved mechanical properties such as stiffness and impact resistance. An article according to various examples is prepared by providing an extruded sheet followed by thermoforming. Compared e.g. to an article made by injection moulding of a composition comprising a polyolefin and glass fibers, certain examples control for the distribution of the glass fibers in the extruded sheet such that it has improved uniformity. Such a uniform distribution of the glass fibers can be retained during thermoforming. Hence the distribution of the glass fibers in the thermoformed article according to the present subject matter is uniform, which can result in desirable mechanical properties.

Battery covers have limited variations in form, are largely flat and have limited series runs and therefore thermoforming is a high-potential manufacturing technology.

The article is configured to form an outer char coating when exposed to flame. Accordingly, an article for covering battery components in an automotive prime-mover battery pack is provided having good mechanical properties and good fire performance.

The above described and other features are exemplified by the following figures, detailed description, and claims.

### BRIEF DESCRIPTION OF THE DRAWINGS

The following Figures are exemplary embodiments, which are provided to illustrate the present disclosure. The figures are illustrative of the examples, which are not intended to limit devices made in accordance with the disclosure to the materials, conditions, or process parameters set forth herein.

FIG. 1 is a perspective view of a portion of a vehicle body and frame with the battery pack separated from the structure (FIG. 1 of US2012/0160088);

FIG. 2 illustrates an embodiment of an article for covering battery components in an automotive prime-mover battery pack according to various examples;

FIG. 3A is an illustration of a flame test;

FIG. 3B is a photograph of the flame test explained in relation to Example 1;

FIG. 4 is a graphical illustration of the compression testing explained in relation to Example 1;

FIG. 5 is a graphical illustration of the tensile test data in 0 deg and 90 deg orientation of Example 1.

FIG. 6 illustrates an embodiment of a top cover of Example 2;

FIG. 7 is a graphical illustration of the thickness distribution of the top cover of Example 2;

FIG. 8 is a graphical illustration of the stress distribution of the top cover of Example 2;

FIG. 9 is a graphical illustration of the thickness distribution along lines x=250, 40, and −240 of the top cover of Example 2; and

FIG. 10 is a graphical illustration of the thickness distribution along y=0 of the top cover of Example 2.

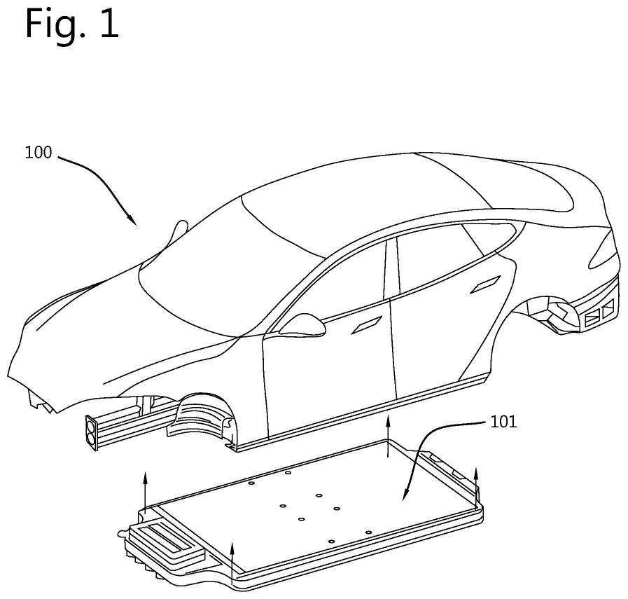

### DETAILED DESCRIPTION

A thermoplastic polymer composition was developed that can meet the stringent mechanical and fire performance requirements such that it can be used as a top cover for covering battery components in an automotive prime-mover battery pack. The thermoplastic polymer composition comprises a polyolefin and glass fibers. The thermoplastic polymer composition may further comprise an intumescent flame retardant composition.

Intumescent flame retardant compositions can generally be used to restrain, retard, or suppress burning processes. A thermoplastic polymer composition comprising an intumescent flame retardant composition begins to swell and char when exposed to flames and then rapidly react to become a compact foam that delays heat migration. When exposed to flames and/or high heat, an article such as a battery cover comprising an intumescent flame retardant composition can expand and produce a char, which can insulate the surface of the battery components under the battery cover and aid in keeping oxygen away from the battery components, thus protecting them from burning and/or damage caused by flames.

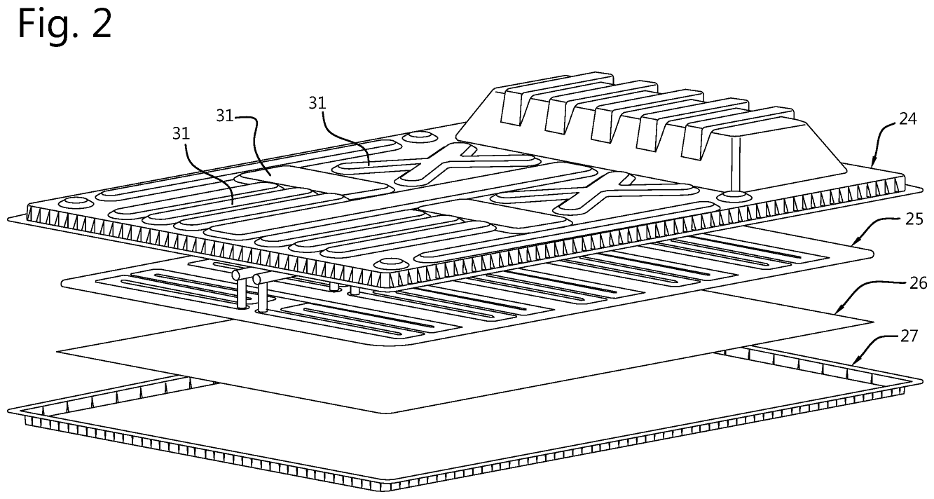

According to the present disclosure, such polymer composition can be used for preparing a top cover of an article for covering battery components in an automotive prime-mover battery pack by extrusion and thermoforming. An example of such article is illustrated in FIG. 2. FIG. 2 illustrates an embodiment of an article for covering battery components in an automotive prime-mover battery pack according to various examples. In this embodiment, the article comprises a top cover 24, a thermal management system 25, an insulating material layer 26 and a bottom cover 27. The top cover 24 comprises ribs 31 and/or edges 31 in order to increase its stiffness. The thermal management system 25 and the insulating material layer 26 are described in detail in WO2021069115A1.

### Thermoplastic Polymer Composition

The thermoplastic polymer composition may have a relatively low melt flow index (MFI). The relatively low MFI of the thermoplastic polymer composition allows preparing an extruded article in a stable manner. Compared e.g. to injection moulding, extrusion allows a homogeneous distribution of glass fibers and thus a relatively low MFI of the composition allows obtaining the final article having desirable properties in a stable manner.

Accordingly, preferably, the thermoplastic polymer composition has a melt flow index as measured according to ISO1133-1:2011 (2.16 kg/230° C.) of 0.1 to 20 dg/min, for example at least 0.5 dg/min, at least 1.0 dg/min or at least 1.5 dg/min and/or at most 10 dg/min or at most 5 dg/min.

### Polyolefin

The thermoplastic polymer composition comprises a polyolefin.

Preferably, the thermoplastic polymer composition comprises at least 80 wt % of the polyolefin, for example at least 90 wt %, at least 93 wt %, at least 95 wt %, at least 97 wt % at least 98 wt % or at least 99 wt % of the polyolefin based on the thermoplastic polymer composition. In a special embodiment, the thermoplastic polymer composition consists of the polyolefin.

The polyolefin is preferably chosen from the group of propylene-based polymers (polypropylenes), elastomers of ethylene and α-olefin comonomer having 4 to 8 carbon atoms, and any mixtures thereof.

Preferably, the polyolefin comprises a propylene-based polymer. Preferably, the thermoplastic polymer composition comprises at least 80 wt % of the propylene-based polymer, for example at least 90 wt %, at least 93 wt %, at least 95 wt %, at least 97 wt % at least 98 wt % or at least 99 wt % of the propylene-based polymer based on the thermoplastic polymer composition. In a special embodiment, the thermoplastic polymer composition consists of the propylene-based polymer.

Preferably, the propylene-based polymer is at least one selected from the group consisting of a propylene homopolymer, a propylene random copolymer and a heterophasic propylene copolymer and mixtures thereof, preferably wherein the polyolefin comprises a propylene random copolymer; a propylene homopolymer and a heterophasic propylene copolymer; or a propylene homopolymer and a propylene random copolymer.

A propylene homopolymer can be obtained by polymerizing propylene under suitable polymerization conditions. A propylene copolymer can be obtained by copolymerizing propylene and one or more other α-olefins, preferably ethylene, under suitable polymerization conditions. The preparation of propylene homopolymers and copolymers is, for example, described in Moore, E. P. (1996) Polypropylene Handbook. Polymerization, Characterization, Properties, Processing, Applications, Hanser Publishers: New York.

The random propylene copolymer may comprise as the comonomer ethylene and/or an α-olefin chosen from the group of α-olefins having 4 to 10 C-atoms, preferably ethylene, 1-butene, 1-hexene or any mixtures thereof. The amount of the comonomer is preferably at most 10 wt % based on the random propylene copolymer, for example in the range from 2-7 wt % based on the random propylene copolymer.

Polypropylenes can be made by any known polymerization technique as well as with any known polymerization catalyst system. Regarding the techniques, reference can be given to slurry, solution or gas phase polymerizations; regarding the catalyst system reference can be given to Ziegler-Natta, metallocene or single-site catalyst systems. All are, in themselves, known in the art.

Heterophasic propylene copolymers are generally prepared in one or more reactors, by polymerization of propylene in the presence of a catalyst and subsequent polymerization of an ethylene-α-olefin mixture. The resulting polymeric materials are heterophasic, but the specific morphology usually depends on the preparation method and monomer ratios used.

The heterophasic propylene copolymers can be produced using any conventional technique known to the skilled person, for example multistage process polymerization, such as bulk polymerization, gas phase polymerization, slurry polymerization, solution polymerization or any combinations thereof. Any conventional catalyst systems, for example, Ziegler-Natta or metallocene may be used. Such techniques and catalysts are described, for example, in WO06/010414; Polypropylene and other Polyolefins, by Ser van der Ven, Studies in Polymer Science 7, Elsevier 1990; WO06/010414, U.S. Pat. Nos. 4,399,054 and 4,472,524.

Preferably, the heterophasic propylene copolymer is made using Ziegler-Natta catalyst.

The heterophasic propylene copolymer may be prepared by a process comprising
polymerizing propylene and optionally ethylene and/or α-olefin in the presence of a catalyst system to obtain the propylene-based matrix and
subsequently polymerizing ethylene and α-olefin in the propylene-based matrix in the presence of a catalyst system to obtain the dispersed ethylene-α olefin copolymer. These steps are preferably performed in different reactors. The catalyst systems for the first step and for the second step may be different or same.

The heterophasic propylene copolymer of the composition consists of a propylene-based matrix and a dispersed ethylene-α-olefin copolymer. The propylene-based matrix typically forms the continuous phase in the heterophasic propylene copolymer. The amounts of the propylene-based matrix and the dispersed ethylene-α-olefin copolymer may be determined by ¹³C-NMR, as well known in the art.

The propylene-based matrix consists of a propylene homopolymer and/or a propylene copolymer consisting of at least 70 wt % of propylene monomer units and at most 30 wt % of comonomer units selected from ethylene monomer units and α-olefin monomer units having 4 to 10 carbon atoms, for example consisting of at least 80 wt % of propylene monomer units and at most 20 wt % of the comonomer units, at least 90 wt % of propylene monomer units and at most 10 wt % of the comonomer units or at least 95 wt % of propylene monomer units and at most 5 wt % of the comonomer units, based on the total weight of the propylene-based matrix.

Preferably, the comonomer in the propylene copolymer of the propylene-based matrix is selected from the group of ethylene, 1-butene, 1-pentene, 4-methyl-1-pentene, 1-hexen, 1-heptene and 1-octene, and is preferably ethylene.

Preferably, the propylene-based matrix consists of a propylene homopolymer.

The propylene-based matrix may e.g. be present in an amount of 50 to 95 wt %, for example the propylene-based matrix is present in an amount of 60 to 85 wt % based on the total heterophasic propylene copolymer.

The amount of ethylene monomer units in the ethylene-α-olefin copolymer may e.g. be 20 to 65 wt %. The amount of ethylene monomer units in the dispersed ethylene-α-olefin copolymer in the heterophasic propylene copolymer may herein be sometimes referred as RCC2.

The α-olefin in the ethylene-α-olefin copolymer is preferably chosen from the group of α-olefins having 3 to 8 carbon atoms. Examples of suitable α-olefins having 3 to 8 carbon atoms include but are not limited to propylene, 1-butene, 1-pentene, 4-methyl-1-pentene, 1-hexen, 1-heptene and 1-octene. More preferably, the α-olefin in the ethylene-α-olefin copolymer is chosen from the group of α-olefins having 3 to 4 carbon atoms and any mixture thereof, more preferably the α-olefin is propylene, in which case the ethylene-α-olefin copolymer is ethylene-propylene copolymer.

The dispersed ethylene-α-olefin copolymer is present in an amount of 50 to 5 wt %. Preferably, the dispersed ethylene-α-olefin copolymer is present in an amount of 40 to 15 wt % based on the total heterophasic propylene copolymer.

In the heterophasic propylene copolymer in the composition, the sum of the total weight of the propylene-based matrix and the total weight of the dispersed ethylene-α-olefin copolymer is 100 wt % of the heterophasic propylene copolymer.

The α-olefin in the ethylene-α-olefin copolymer is preferably chosen from the group of α-olefins having 3 to 8 carbon atoms and any mixtures thereof, preferably the α-olefin in the ethylene-α-olefin copolymer is chosen from the group of α-olefins having 3 to 4 carbon atoms and any mixture thereof, more preferably the α-olefin is propylene, in which case the ethylene-α-olefin copolymer is ethylene-propylene copolymer. Examples of suitable α-olefins having 3 to 8 carbon atoms, which may be employed as ethylene comonomers to form the ethylene α-olefin copolymer include but are not limited to propylene, 1-butene, 1-pentene, 4-methyl-1-pentene, 1-hexene, 1-heptene and 1-octene.

The polyolefin in the thermoplastic polymer composition can be a mixture of a propylene homopolymer and a heterophasic propylene copolymer.

When the polyolefin is a mixture of polyolefins having different MFI, the MFI of the mixture can be calculated by the skilled person based on the MFI of each of the polyolefins.

The polyolefin may have an MFI as measured according to ISO1133-1:2011 (2.16 kg/230° C.) of 1.0 to 100 dg/min, e.g. 5.0 to 50 dg/min.

In some particularly preferred embodiments, the polyolefin in the thermoplastic polymer composition comprises or consists of a first polyolefin, preferably a first propylene-based polymer, having an MFI as measured according to ISO1133-1:2011 (2.16 kg/230° C.) of at least 20 dg/min and a second polyolefin, preferably a second propylene-based polymer, having an MFI as measured according to ISO1133-1:2011 (2.16 kg/230° C.) of less than 20 dg/min. This may result in a higher melt strength of the thermoplastic polymer composition than a thermoplastic polymer composition having the same melt flow index comprising one type of polyolefin. Preferably, the weight ratio between said propylene homopolymer and said heterophasic propylene copolymer is 5:1 to 1:5, for example 3:1 to 1:1.

In some particularly preferred embodiments, the polyolefin in the thermoplastic polymer composition comprises or consists of a propylene homopolymer having an MFI as measured according to ISO1133-1:2011 (2.16 kg/230° C.) of 25 to 50 dg/min and a heterophasic propylene copolymer having an MFI as measured according to ISO1133-1:2011 (2.16 kg/230° C.) of 0.1 to 5.0 dg/min. Preferably, the weight ratio between said propylene homopolymer and said heterophasic propylene copolymer is 3:1 to 1:1.

Preferably, the amount of the polyolefin with respect to the thermoplastic polymer composition is 20 to 70 wt %, more preferably 30 to 60 wt %, more preferably 40 to 50 wt %.

### Glass Fibers

Glass fibers may be so-called long glass fibers or short glass fibers. The long glass fibers may have length of at least 10 mm, for example 10 to 55 mm, for example 10 to 40 mm, for example 10 to 30 mm or 10 to 20 mm. The short glass fibers may have length of length of less than 10 mm, for example 2 to 7 mm, for example 3 to 5 mm. The length of the glass fibers is determined before they are melt-mixed with polyolefin.

The thickness of the glass fibers can be 5 to 50 μm, for example 7 to 30 μm. Usually the glass fibers are circular in cross section meaning the thickness as defined above would mean diameter.

The amount of the glass fibers with respect to the thermoplastic polymer composition may be 10 to 70 wt %, for example 20 to 60 wt %, for example 25 to 40 wt %.

The total amount of the polyolefin and the glass fibers with respect to the thermoplastic polymer composition may be at least 50 wt %, for example 55 to 95 wt %, for example 60 to 90 wt %, for example 65 to 85 wt %.

### Intumescent Flame Retardant Composition

The thermoplastic polymer composition may further comprise an intumescent flame retardant composition. The intumescent flame retardant composition may comprise various components to produce an outer char coating when exposed to flame and/or high heat. A thermoplastic polymer composition comprising an intumescent flame retardant comprises a carbon source and the intumescent flame retardant composition may comprise a film-forming binder, an acid source and a blowing agent. The carbon source can be an organic material that decomposes to a char consisting primarily of carbon when exposed to fire or heat. The carbon source may be the polyolefin in the thermoplastic polymer composition. In the presence of an acid source, which promotes the formation of the char, and a blowing agent, which expands the char, the carbon source can generate an expanded, insulating, cellular structure that can be several times thicker than the original thickness, when exposed to fire or heat.

The intumescent flame retardant composition may comprise at least one phosphate selected from the group consisting of melamine phosphate, melamine polyphosphate, melamine pyrophosphate, piperazine phosphate, piperazine polyphosphate, piperazine pyrophosphate, 2-methylpiperazine monophosphate, tricresyl phosphate, alkyl phosphates, haloalkyl phosphates, tetraphenyl pyrophosphate, poly(2-hydroxy propylene spirocyclic pentaerythritol bisphosphate) and poly(2,2-dimethylpropylene spirocyclic pentaerythritol bisphosphonate).

The intumescent flame retardant composition may comprise ammonium polyphosphate. The intumescent flame retardant composition may comprise ammonium polyphosphate and at least one of the above-mentioned phosphate.

The intumescent flame retardant composition may comprise comprises ammonium polyphosphate and at least two of the above-mentioned phosphate.

The intumescent flame retardant composition may comprise ammonium polyphosphate, melamine polyphosphate and piperazine phosphate.

The intumescent flame retardant composition may comprise melamine phosphate and piperazine pyrophosphate.

The intumescent flame retardant composition may further comprise an inorganic flame retardant, e.g. zinc oxide.

The intumescent flame retardant composition may be particles comprising the phosphate described above and zinc oxide. The amount of zinc oxide with respect to the particles can e.g. be 1 to 10 wt %.

The intumescent flame retardant composition may comprise an aromatic phosphate ester.

In some embodiments, the amount of the intumescent flame retardant composition, in particular the phosphate described above, with respect to the thermoplastic polymer composition is 0.1 to 50 wt %, e.g. at least 1.0 wt %, at least 5.0 wt %, at least 10 wt %, at least 20 wt %, at least 30 wt % and/or at most 45 wt % or at most 40 wt %. In some embodiments, the amount of the intumescent flame retardant composition, in particular the phosphate described above, with respect to thermoplastic polymer composition is 15 to 30 wt %.

The film-forming binder is capable of binding the other components of the intumescent flame retardant composition together upon drying or curing. The binder can comprise at least one of a thermoplastic polymer, a thermosetting polymer, or an elastomer. Examples of thermoplastic polymers are (meth)acrylic resins, poly(vinyl acetate), vinyl acetate-(meth)acrylic copolymers, ethylene-vinyl acetate copolymers, ethylene-vinyl acetate-vinyl chloride terpolymers, cellulosic resins, poly(vinyl chloride), poly(vinylidene chloride), and fluoropolymers. Examples of thermosetting polymers include cyanate esters, unsaturated polyesters, alkyds, amino resins, melamine-formaldehyde resins, urea-formaldehyde resins, phenol-formaldehyde resins, and silicone resins. Examples of elastomeric resins include thermoplastic polyurethanes, thermoplastic polyamides, thermoplastic copolyetheresters, and chlorinated rubbers. The intumescent flame retardant composition can comprise 50 to 90 weight percent, or 60 to 80 weight percent of the film-forming binder based on the total weight of the intumescent flame retardant composition.

The acid source is an acid, or a material that under the high temperature conditions of a fire, generates an acid. The acid source can comprise at least one of ammonium chloride, ammonium polyphosphate, ammonium sulfate, boric acid, diammonium phosphate, hydrochloric acid, hypophosphorous acid, melamine pentaerythritol diphosphate, melamine phosphate, melamine polyphosphate, melamine pyrophosphate, metaphosphoric acid, monoammonium phosphate, monopotassium phosphate, nitric acid, orthophosphoric acid, phosphonic acid, phosphoric acid, pyrophosphoric acid, or sulfuric acid. The intumescent flame retardant composition can comprise 4 to 60 weight percent, or 10 to 40 weight percent of the acid source based on the total weight of the intumescent flame retardant composition.

The blowing agent is a compound that produces non-flammable gases when undergoing thermal decomposition. The blowing agent provides a means for the expansion of char produced from the carbon source by fire or heat to form an insulating cellular structure. The blowing agent increases the thickness of the carbon char when exposed to fire or heat by thermal decomposition and concurrent evolution of a non-combustible gas. For example, melamine undergoes self-condensation reactions above its melting point of 350 to 400° C., generating ammonia; chlorinated paraffin waxes generate hydrochloric acid; and aluminum trihydrate generates water. The expansion of the char and formation of a cellular structure enhances the insulating properties of the material. Furthermore, the blowing agent absorbs energy when it evolves a gas, thereby removing energy from the surface and cooling the material. The non-combustible gas also dilutes the concentrations of combustible gasses that are produced in a fire and dilutes the concentration of oxygen in the atmosphere adjacent to the substrate. The intumescent flame retardant composition can comprise 1 to 30 weight percent, or 5 to 20 weight percent of the blowing agent based on the total weight of the intumescent flame retardant composition.

The blowing agent can comprise at least one of melamine, melamine polyphosphate, melamine cyanurate, melamine isocyanurate, tris(hydroxyethyl) isocyanurate, dicyandiamide, urea, dimethylurea, guanidine, cyanoguanidine, glycine, chlorinated paraffin wax, alumina trihydrate, magnesium hydroxide, or zinc borate hydrate. Two or more blowing agents can be present with different decomposition temperatures. An example of a mixture of blowing agents is at least one chlorine-containing blowing agent which decomposes at a lower temperature, for example, a chlorinated paraffin wax, and at least one nitrogen-containing blowing agent which decomposes at a higher temperature, for example, melamine, dicyandiamide, urea, or guanidine.

The total amount of the polyolefin, the glass fibers and the intumescent flame retardant composition can be at least 90 wt % of the thermoplastic polymer composition.

### Additives

The thermoplastic polymer composition may further contain additives, for instance nucleating agents and clarifiers, stabilizers, fillers, plasticizers, anti-oxidants, lubricants, antistatics, scratch resistance agents, impact modifiers, acid scavengers, recycling additives, coupling agents, anti-microbials, anti-fogging additives, slip additives, anti-blocking additives, polymer processing aids, colorants and the like. Such additives are well known in the art. The skilled person will know how to choose the type and amount of additives such that they do not detrimentally influence the aimed properties.

The amount of the additives with respect to the thermoplastic polymer composition may e.g. be 0.1 to 10 wt % or 1.0 to 5.0 wt %.

Preferably, the total of the polyolefin, the glass fibers, the intumescent flame retardant composition and the additives in the thermoplastic polymer composition is 100 wt % with respect to the thermoplastic polymer composition.

Additives can comprise a coupling agent. Coupling agents can be used to improve the adhesion between the matrix thermoplastic polymer and the fiber reinforcements. Suitable examples of coupling agents used for the glass fibres include organofunctional silanes.

Further suitable examples of the coupling agent include a functionalized polyolefin grafted with an acid or acid anhydride functional group. The polyolefin is preferably polyethylene or polypropylene, more preferably polypropylene. The polypropylene may be a propylene homopolymer or a propylene copolymer. The propylene copolymer may be a propylene-α-olefin copolymer consisting of at least 70 wt % of propylene and up to 30 wt % of α-olefin, for example ethylene, for example consisting of at least 80 wt % of propylene and up to 20 wt % of α-olefin, for example consisting of at least 90 wt % of propylene and up to 10 wt % of α-olefin, based on the total weight of the propylene-based matrix. Preferably, the α-olefin in the propylene-α-olefin copolymer is selected from the group of α-olefins having 2 or 4-10 carbon atoms and is preferably ethylene. Examples of the acid or acid anhydride functional groups include (meth)acrylic acid and maleic anhydride. A particularly suitable material is for example maleic acid functionalized propylene homopolymer (for example Exxelor PO 1020 supplied by Exxon).

The amount of the coupling agent with respect to the thermoplastic polymer composition may e.g. be 0.5 to 5.0 wt %, preferably 1.0 to 4.0 wt %.

In some preferred embodiments, the additives comprises a slip additive, for example erucamide.

Disclosed herein is also a process for preparing the article according to the present disclosure, comprising the steps of: i) extruding a thermoplastic polymer composition comprising a polyolefin and glass fibers to obtain a sheet and ii) thermoforming the sheet to obtain the top cover. The article may further comprise a bottom cover.

### Step i)

Step i) may involve introducing the polyolefin, the glass fibers and the optional components described herein to an extruder, melting the polyolefin, melt-mixing the polyolefin and the glass fibers and the optional components to obtain a melt of the thermoplastic polymer composition and extruding the melt. During the melt-mixing, the glass fibers may break and thus the length of the glass fibers before the melt-mixing may be different from the length of the glass fibers in the extruded sheet and thus the final thermoformed article.

The polyolefin and the glass fibers may be introduced to the extruder in the form of pellets of a sheathed continuous multifilament strand comprising a core that extends in the longitudinal direction and a polymer sheath which intimately surrounds said core, wherein the core comprises at least one continuous glass multifilament strand comprising the fibers and the polymer sheath comprising the polyolefin. In this case, the length of the glass filaments in the pellets is substantially the same as the pellet length. This is particularly suitable when the glass fibers are long glass fibers. The polymer sheath may further comprise the optional intumescent flame retardant composition and the other optional additives.

The polyolefin and the glass fibers may be introduced to the extruder in the form of pellets made by pultrusion of the glass fibers in the polyolefin. This is particularly suitable when the glass fibers are long glass fibers.

The polyolefin and the glass fibers may be introduced to the extruder by introducing the glass fibers separately from (pellets of) the polyolefin. Short glass fibers may be introduced e.g. to a side feeder of the extruder. In another embodiment, continuous glass fiber rovings may be pulled into the extruder where they are broken by stretch breakage, in which case the glass fibers may be long glass fibers (known as direct long fiber thermoplastics (DLFT)).

A masterbatch may be suitably used for introducing some or all of the optional intumescent flame retardant composition and the other optional additives.

Preferably, the sheet obtained by step i) has a thickness of 1 to 10 mm, preferably 2 to 8 mm, more preferably 2.5 to 6 mm. Such thickness is suitable for the subsequent thermoforming step. The sheet can have a weight in the range of 5-10 kg.

### Step ii)

The thermoforming may be performed by known thermoforming methods, such as vacuum forming, pressure forming, solid pressure forming, solid press forming, twin sheet forming and stamping forming. Such methods generally are carried out by heating the sheets above its softening temperature in the plastic deformation range, for instance with rolls, heating plates or indirect heating means, like radiant electric heaters, and forcing the sheets to fit the shape of a mold, for instance by sucking them against the mold.

The thermoforming may be performed under pressure or under vacuum. The pressure shall be sufficient enough for the sheets to conform to the final shape. For instance, the thermoforming under pressure may e.g. be performed at a pressure of 0.1 to 10 KPa. The thermoforming under vacuum may e.g. be performed at a pressure of −1 to −100 KPa.

The thermoforming may be performed e.g. at a temperature of 100° C. to 270° C. The suitable temperature may be selected according to the thermoplastic polymer composition used for making the sheet to be subjected to thermoforming, e.g. depending on whether the composition comprises a flame retardant. If the composition comprises an intumescent flame retardant composition, the temperature may be selected such that decomposition of the organic components in intumescent flame retardant composition, e.g. the phosphate, is prevented, e.g. at most 240° C. For example, the top cover can withstand a flame at a temperature of 1,000° C. which is held 50-70 mm away from a flat surface of top cover having a thickness of 3 millimeters for 5 minutes. After 5 minutes of the exposure to flame, the top cover forms an outer char coating and the temperature on the opposite side of the top cover does not exceed 300° C.

The top cover can have dimensions of (1000-2000) mm*(2000-3000) mm*(100-500) mm, for example (1000-1500) mm*(2000-2500) mm*(100-500) mm. The top cover can have a portion which has a smaller thickness than another portion, but the thickness can range from e.g. 1 to 10 mm, for example 2 to 8 mm, for example 2.5 to 6 mm. The top cover can have a weight in the range of 5-10 kg.

For example, the top cover has at least one of
a melting point of 110° C. to 270° C. as determined in accordance with ASTM F2625-10 (2016);
a heat capacity of 1400 to 2400 KJ/kg K as determined in accordance with ASTM E1269-11 (2018);
a heat of fusion at least 120 J/g as determined in accordance with ASTM F2625-10 (2016); and
a pyrolysis temperature of at least 300° C. as determined in accordance with ASTM D7309-20.

It is noted that the invention relates to the subject-matter defined in the independent claims alone or in combination with any possible combinations of features described herein, preferred in particular are those combinations of features that are present in the claims. It will therefore be appreciated that all combinations of features relating to the composition according to the invention; all combinations of features relating to the process according to the invention and all combinations of features relating to the composition according to the invention and features relating to the process according to the invention are described herein.

It is further noted that the term ‘comprising’ does not exclude the presence of other elements. However, it is also to be understood that a description on a product/composition comprising certain components also discloses a product/composition consisting of these components. The product/composition consisting of these components may be advantageous in that it offers a simpler, more economical process for the preparation of the product/composition. Similarly, it is also to be understood that a description on a process comprising certain steps also discloses a process consisting of these steps. The process consisting of these steps may be advantageous in that it offers a simpler, more economical process.

### EXAMPLES

### Materials Used

PP1: SABIC® PP 595A, propylene homopolymer (Melt flow index of 47 dg/min as measured according to ISO1133 at 230° C./2.16 kg, MW of 165 kg/mol, MWD of 7.6)
PP2: SABIC® PP 83MF10, heterophasic propylene copolymer consisting of propylene homopolymer and propylene-ethylene copolymer (Melt flow index of 1.8 dg/min as measured according to ISO1133 at 230° C./2.16 kg; ethylene content (Tc) in heterophasic propylene copolymer of 13.9±1.1 wt %, MW of 422 kg/mol, MWD of 7.4)

Herein, MW is measured according to ASTM D6474-12.

GF: short glass fiber having length of 3-5 mm and diameter of 10 micron.

Intumescent flame retardant composition: 10-15 wt % ammonium polyphosphate, 60-70 wt % melamine phosphate, 15-20 wt % phosphoric acid compound (not melamine phosphate) and 3-8 wt % zinc oxide.

### Example 1

### Sheet Extrusion

Components shown in table 1 were fed into a hoper of a single screw extruder L/D=33 having temperature profile in the range of 160° at the first section of the extruder and 180°, 200° end section of the extruder. Die temperature average was 190° C. After material leaves the die, it enters calendaring rolls. Calander temperature, ROLL 1=90°; ROLL 2=123°; ROLL 3=135°; ROLL 4=128°. Throughput of 420 kg/hrs.

TABLE 1

| | wt % |
|---|---|
| PP1 | 24.5 |
| PP2 | 21.5 |
| GF | 30 |
| intumescent flame retardant composition | 20 |
| coupling agent | 3 |
| antioxidant | 0.2 |
| slip agent | 0.1 |
| stabilizer | 0.2 |
| color master batch | 0.5 |

The MFI of the composition was 2 dg/min according to ISO1133 at 230° C./2.16 kg.

A sheet having a thickness of 3 millimeters was obtained. The sheet was cooled and cut to have lateral dimensions of 570 by 800 millimeters.

### Properties of Sheet

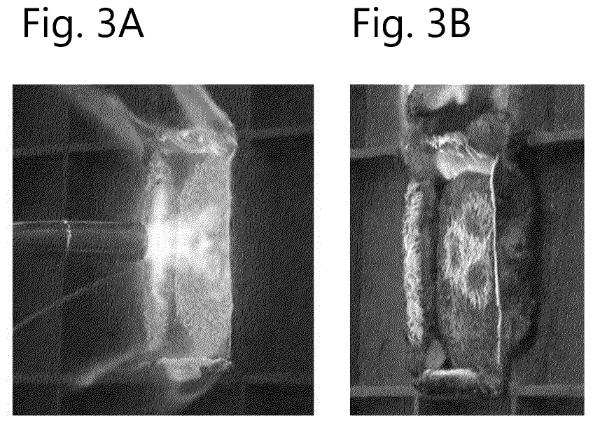

The obtained sheet was tested for fire performance using a horizontal flame exposure at 1,000 degrees Celsius (° C.). An illustration of a horizontal flame exposure is illustrated in FIG. 3A, where the flame was located 50-70 millimeters away from a planar surface of the sample. After 5 minutes of exposure to the flame, the temperature on the opposite side of the extruded sheet was measured to be only 200 to 300° C. FIG. 3B is a photographic image of an extruded sheet after flame exposure. FIG. 3B shows that an intumescent coating formed on the sheet.

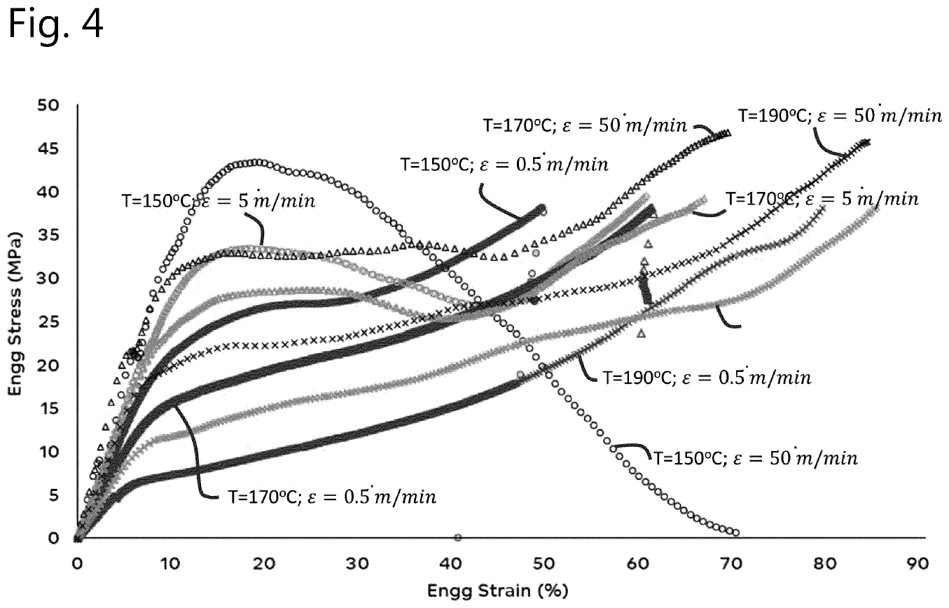

The obtained sheet was compression tested under uniaxial compression at different temperatures of 150° C., 170° C., and 190° C. at different strain rates of 0.5 s⁻¹, 5 s⁻¹, and 50 s⁻¹. The results are shown in FIG. 4. FIG. 4 shows that the sheets displayed good compression testing results. The testing was done by ASTM D638-14 standard test method for compressive properties of rigid plastics. ISO type 3 tensile bar specimen was used which was conditioned for 40 hours at 23° C. and 50% relative humidity.

It is noted that this data was fitted with non-linear viscoelastic K-BKZ Rheological Constitutive Model coupled with WLF-model for temperature dependence to estimate the model parameters that were used in the thermoforming simulation. The model parameters are shown in the Table 2 below.

TABLE 2

| Relaxation | Modulus |
|---|---|
| Time (s) | (Pa) |
| 0.01 | 3e+07 |
| 0.1 | 7.0e+05 |
| 1 | 1.25e+06 |
| 1000 | 2e+06 |

WLF Parameters

| | |
|---|---|
| Reference | 170 |
| Temperature (° C.) | |
| C1 (K) | 10 |
| C2 (K) | 50 |

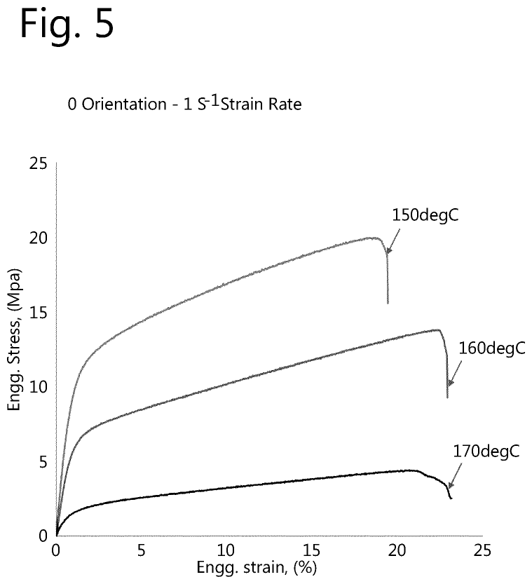

The obtained sheet was characterized for tensile measurements in 0 and 90 deg direction, 150° C., 160° C., and 170° C. temperatures and at different strain rates of 0.1 s⁻¹, 1 s⁻¹ and 10 s⁻¹. The results are shown in FIG. 5. The tensile test results in 0 deg and 90 deg direction show that the mechanical properties are much higher in the extrusion direction compared to transverse direction.

It has thus been shown that the sheet has good mechanical properties and fire performance. It will be understood that an article made by thermoforming such sheet also has good mechanical properties and fire performance.

### Thermoforming

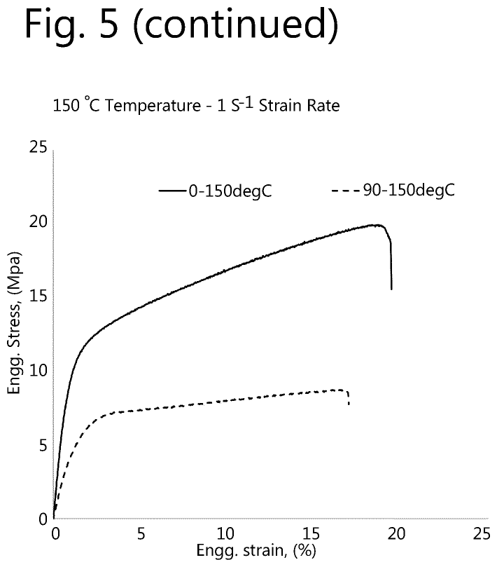

A simulation was performed for subjecting the obtained sheet to thermoforming under vacuum and pressure to form a battery top cover part as illustrated in FIG. 6. The settings for vacuum pressure and tool movement as well as other process settings used for forming of the part are shown in the Table 3 below.

TABLE 3

| | Time (ms) | Pressure (KPa) | Tool position (mm) |
|---|---|---|---|
| 1 | 0 | 0.2 | −150 |
| 2 | 7500 | 0.2 | −150 |
| 3 | 15000 | 0.2 | −150 |
| 4 | 16500 | −50 | −3 |
| 5 | 17000 | −75 | −3 |
| 6 | 25000 | −75 | −3 |

| Parameter | Units | Values |
|---|---|---|
| Temperature of Tool | ° C. | 50 |
| Heat Transfer Coefficient between | W/m2K | 400 |
| Tool and Material | | |
| Friction Coefficient between Tool | | 1 |
| and Material | | |
| Ambient Air Temperature | ° C. | 20 |
| Heat Transfer Coefficient between | W/m2K | 5.7 |
| Ambient Air and Material | | |

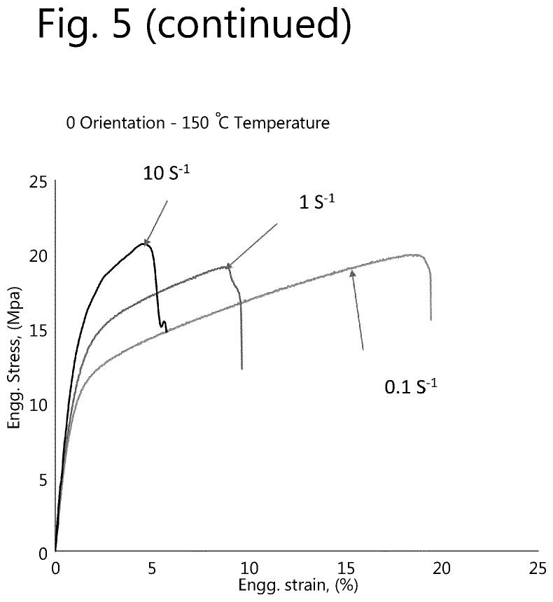

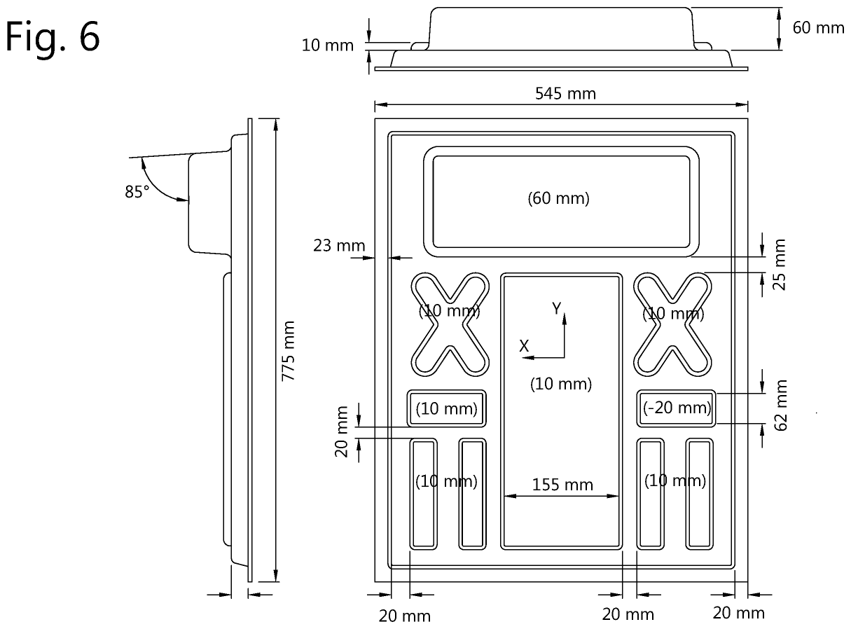

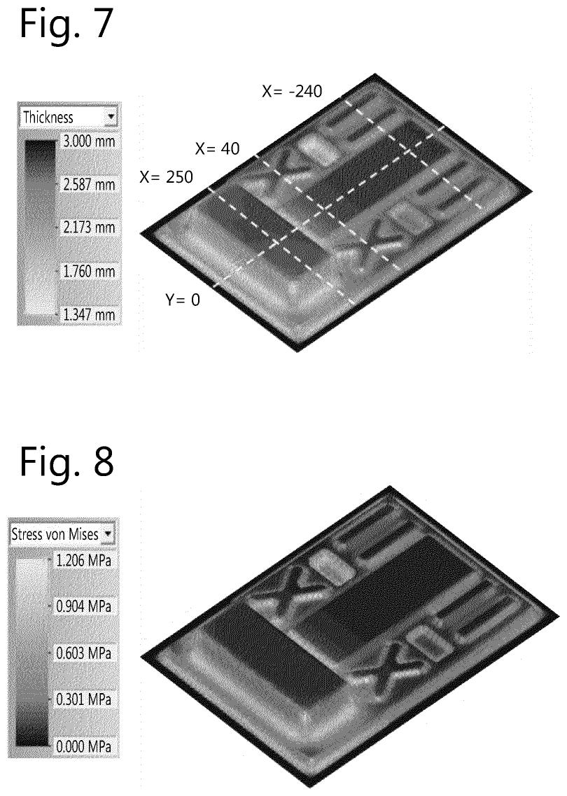

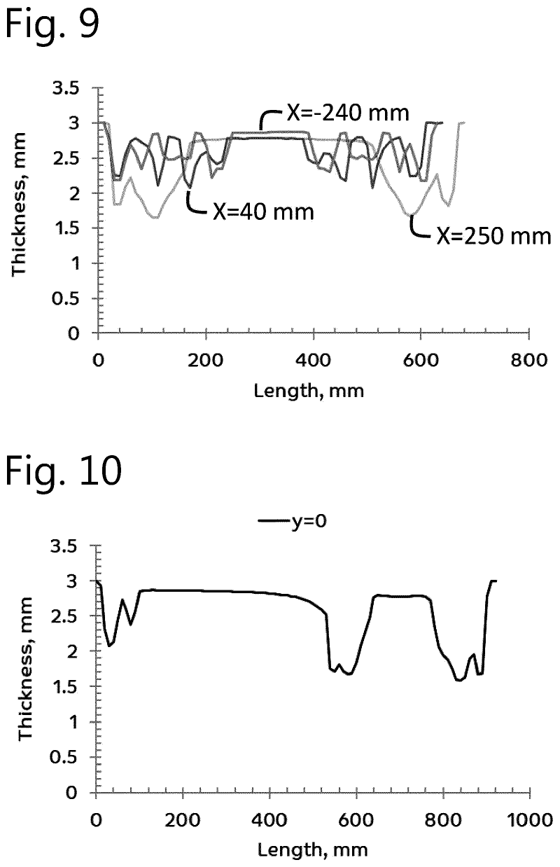

The battery top cover part formed using vacuum thermoforming has a thickness and stress distribution as shown in FIG. 7 and FIG. 8, respectively. FIG. 9 is a graphical illustration of the thickness distribution along lines x=250, 40, and −240 as illustrated in FIG. 7 and FIG. 10 a graphical illustration of the thickness distribution along line y=0 as illustrated in FIG. 7.

The minimum thickness observed in the formed part was 1.6 millimeters which was also the areas where part experiences high stresses.

1. An article for covering battery components in an automotive prime-mover battery pack, the article comprising a top cover having an outer major surface and an inner major surface that is shaped to conform to the battery components, wherein the top cover is prepared by extrusion of a composition comprising a polyolefin and glass fibers to obtain a sheet and subsequent thermoforming of the sheet and wherein the article is configured to form an outer char coating when exposed to flame.

2. The article according claim 1, wherein the composition has a melt flow index as measured according to ISO1133-1:2011 (2.16 kg/230° C.) of 0.1 to 20 dg/min.

3. The article according to claim 1, wherein an amount of the polyolefin with respect to the composition is 20 to 70 wt % and/or an amount of the glass fibers with respect to the thermoplastic polymer composition is 20 to 70 wt %.

4. The article according to claim 1, wherein the polyolefin comprises a propylene-based polymer and/or an elastomer of ethylene and an α-olefin comonomer having 4 to 8 carbon atoms, wherein the propylene-based polymer is at least one selected from the group consisting of a propylene homopolymer, a propylene random copolymer, a heterophasic propylene copolymer and mixtures thereof.

5. The article according to claim 1, wherein the polyolefin comprises or consists of a propylene homopolymer having a melt flow index as measured according to ISO1133-1:2011 (2.16 kg/230° C.) of 25 to 50 dg/min and a heterophasic propylene copolymer having a melt flow index as measured according to ISO1133-1:2011 (2.16 kg/230° C.) of 0.1 to 5.0 dg/min.

6. The article according to a claim 1, wherein the thermoplastic polymer composition further comprises an intumescent flame retardant composition.

7. The article according to claim 6, wherein the intumescent flame retardant composition comprises at least one phosphate selected from the group consisting of melamine phosphate, melamine polyphosphate, melamine pyrophosphate, piperazine phosphate, piperazine polyphosphate, piperazine pyrophosphate, 2-methylpiperazine monophosphate, tricresyl phosphate, alkyl phosphates, haloalkyl phosphates, tetraphenyl pyrophosphate, poly(2-hydroxy propylene spirocyclic pentaerythritol bisphosphate), poly(2,2-dimethylpropylene spirocyclic pentaerythritol bisphosphonate), and ammonium polyphosphate.

8. The article according to claim 6, wherein an amount of the intumescent flame retardant composition, with respect to the composition is 0.1 to 50 wt %.

9. The article according to claim 1, wherein the glass fibers have length of at least 10 mm.

10. The article according to claim 1, wherein the glass fibers have length of less than 10 mm.

11. The article according to claim 1, wherein the top cover has at least one of
a melting point of 110° C. to 270° C. as determined in accordance with ASTM F2625-10 (2016);
a heat capacity of 1400 to 2400 KJ/kg K as determined in accordance with ASTM E1269-11 (2018);
a heat of fusion at least 120 J/g as determined in accordance with ASTM F2625-10 (2016); or
a pyrolysis temperature of at least 300° C. as determined in accordance with ASTM D7309-20.

12. A process for preparing the article according to claim 1, the method comprising the steps of:
i) extruding the composition to obtain a sheet and
ii) thermoforming the sheet to obtain the top cover.

13. The process according to claim 12, wherein the sheet obtained by step i) has a thickness of 1 to 10 mm.

14. The process according to claim 12, wherein the thermoforming is vacuum forming, pressure forming, solid pressure forming, solid press forming, twin sheet forming, or stamping forming.

15. The process according to claim 12, wherein the thermoforming is performed at a pressure of 0.1 to 10 kPa or −1 to −100 kPa.

16. The article of claim 1, wherein the total amount of the polyolefin, the glass fibers and the intumescent flame retardant composition is at least 90 wt % of the composition.

17. The article of claim 1, wherein the total amount of the intumescent flame retardant composition is 15 to 30 wt % with respect to the composition.

18. An article for covering battery components in an automotive prime-mover battery pack, the article comprising a top cover having an outer major surface and an inner major surface that is shaped to conform to the battery components, wherein the top cover is prepared by extrusion of a composition comprising a polyolefin, glass fibers, and an intumescent flame retardant composition to obtain a sheet and subsequent thermoforming of the sheet and wherein the article is configured to form an outer char coating when exposed to flame,
wherein the polyolefin comprises a propylene homopolymer having a melt flow index as measured according to ISO1133-1:2011 (2.16 kg/230° C.) of 25 to 50 dg/min and a heterophasic propylene copolymer having a melt flow index as measured according to ISO1133-1:2011 (2.16 kg/230° C.) of 0.1 to 5.0 dg/min; and
the intumescent flame retardant composition comprises at least one phosphate selected from the group consisting of melamine phosphate, melamine polyphosphate, melamine pyrophosphate, piperazine phosphate, piperazine polyphosphate, piperazine pyrophosphate, 2-methylpiperazine monophosphate, tricresyl phosphate, alkyl phosphates, haloalkyl phosphates, tetraphenyl pyrophosphate, poly(2-hydroxy propylene spirocyclic pentaerythritol bisphosphate), poly(2,2-dimethylpropylene spirocyclic pentaerythritol bisphosphonate), and ammonium polyphosphate.

19. The article of claim 18, wherein a total amount of the intumescent flame retardant composition is 15 to 30 wt % with respect to the composition.

20. An article for covering battery components in an automotive prime-mover battery pack, the article comprising a top cover having an outer major surface and an inner major surface that is shaped to conform to the battery components, wherein the top cover is prepared by extrusion of a composition comprising a polyolefin, glass fibers, and an intumescent flame retardant composition to obtain a sheet and subsequent thermoforming of the sheet and wherein the article is configured to form an outer char coating when exposed to flame,
wherein the polyolefin comprises a propylene homopolymer having a melt flow index as measured according to ISO1133-1:2011 (2.16 kg/230° C.) of 25 to 50 dg/min and a heterophasic propylene copolymer having a melt flow index as measured according to ISO1133-1:2011 (2.16 kg/230° C.) of 0.1 to 5.0 dg/min, a weight ratio between the propylene homopolymer and the heterophasic propylene copolymer is 5:1 to 1:5; and
the intumescent flame retardant composition comprises at least one phosphate selected from the group consisting of melamine phosphate, melamine polyphosphate, melamine pyrophosphate, piperazine phosphate, piperazine polyphosphate, piperazine pyrophosphate, 2-methylpiperazine monophosphate, tricresyl phosphate, alkyl phosphates, haloalkyl phosphates, tetraphenyl pyrophosphate, poly(2-hydroxy propylene spirocyclic pentaerythritol bisphosphate), poly(2,2-dimethylpropylene spirocyclic pentaerythritol bisphosphonate), and ammonium polyphosphate, a total amount of the intumescent flame retardant composition is 15 to 30 wt % with respect to the composition; and
a total amount of the polyolefin, the glass fibers and the intumescent flame retardant composition is at least 90 wt % of the composition.
